(19) United States
(12) Patent Application Publication
(10) Pub. No.: US 2020/0326677 A1
(43) Pub. Date: Oct. 15, 2020

(54) PLUG-IN SENSORY COMMUNICATION DEVICE

(71) Applicant: Johnson Controls Technology Company, Auburn Hills, MI (US)

(72) Inventors: TIMOTHY C. GAMROTH, Dousman, WI (US); JOSEPH PICCOLO, III, Fitzwilliam, NH (US); AVICHAL CHUM, Chandigarh (IN)

(73) Assignee: Johnson Controls Technology Company, Auburn Hills, MI (US)

(21) Appl. No.: 16/381,833

(22) Filed: Apr. 11, 2019

(51) Int. Cl. G05B 19/042; G05B 19/04; G05B 19/418; G06F 1/26; H04L 12/28

(52) U.S. Cl. CPC G05B 19/042; G05B 19/041; G05B 2219/2614; G06F 1/26; H04L 12/2823; G05B 19/4183

(57) ABSTRACT

A sensory communication device for a building space includes a housing, a plug structure attached to the housing, insertable into an electrical outlet to receive power from the electrical outlet, and capable of supporting the housing when inserted into the electrical outlet, sensors located partially within the housing and capable of measuring environmental variables within a building space, a wireless radio that transmits measurements of the environmental variables, and electrical outlets located on an external surface of the housing and electrically connected to the plug structure to provide power to external devices.

### BACKGROUND

The present disclosure relates generally to methods for managing building systems. The present invention relates more particularly to systems and methods for controlling an environment of a building space.

A building management system (BMS) is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

Some building systems include space devices configured to transmit measurements of an environment variable to a system of devices configured to control, monitor, and manage equipment for a particular space or group of spaces.

### SUMMARY

One implementation of the present disclosure is a sensory communication device for a building space. The sensory communication device includes a housing, a plug structure attached to the housing, insertable into an electrical outlet to receive power from the electrical outlet, and capable of supporting the housing when inserted into the electrical outlet, sensors located partially within the housing and capable of measuring environmental variables within a building space, a wireless radio that transmits measurements of the environmental variables, and electrical outlets located on an external surface of the housing and electrically connected to the plug structure to provide power to external devices.

In some embodiments, the sensory communication device includes a feedback controller within the housing. The feedback controller receives values of environmental variables from the sensors, uses the values to generate control commands for a space environment control device that operates to control the environmental variables, and outputs the control command to the space environment control device.

In some embodiments, the sensory communication device transmits the measurements of the environmental variables to a building management system.

In some embodiments, the sensory communication device includes a feedback controller that receives values of an environmental variables from external wireless devices, uses the values to generate control commands for space environment control devices that operate to affect environmental variables, and outputs the control commands to the space environment control device.

In some embodiments, the sensory communication device includes a plug load sensor that measures a power consumption from the external devices plugged into the electrical outlets. In some embodiments, the wireless radio included in the sensory communication device transmits measurements of the power consumption of the external devices received from the plug load sensor to a building management system controller. In some embodiments, the electrical outlets provide 120 AC power to the external devices. In some embodiments, the sensory communication device includes a backup battery that stores and provides power to sensory, the wireless radio, and the electrical outlets.

Another implementation of the present disclosure is a method for control a space environment. The method includes providing a sensory communication device that receives power from an external power source, electrically connecting the sensory communication device to an electrical outlet that provides power from the external power source, powering the sensory communication device with power provided by the external power source, measure environmental variables by locating sensory partially within the housing, transmitting measurements of the environmental variables, and providing electrical outlets on an external surface of the housing.

In some embodiments, powering the sensory communication device includes supplying power from an electrical infrastructure contained within a building. In some embodiments, providing the sensory communication device includes providing a backup battery. In some embodiments, providing electrical outlets includes providing 120 AC power to external devices. In some embodiments, the method includes measuring a power consumption value of the external devices plugged into the electrical outlets.

In some embodiments, the method includes receiving values of an environmental variable from wireless devices, using the values to generate control commands for space environment control devices operating to affect the environmental variables, and transmitting the control commands to the at least one space environment control device.

Yet another implementation of the present disclosure is a plug-in controller device. The plug-in controller device includes a housing, a plug structure connected to the housing and insertable into an electrical outlet to receive power from the electrical outlet and support the housing, sensors located partially within the housing that measure environmental variables within a building space, a processing circuit including a feedback controller located within the housing, a wireless radio that transmits control commands determined by the feedback controller, and electrical outlets located on an external surface of the housing that electrically connect the plug structure to provide power to external devices. The feedback controller receives values of environmental variables from the sensors, determines control commands based on the values, and outputs the control commands.

In some embodiments, the wireless radio receives the values of environmental variables from external wireless devices. In some embodiments, the wireless radio transmits measurements of power consumption of the external devices from a plug load sensor.

In some embodiments, the electrical outlets are configured to provide 120 AC power to the external devices.

In some embodiments, the plug-in controller includes a backup battery that provides an emergency power supply. In some embodiments, the feedback controller detects a power line event and activates the emergency power supply supplied by the backup battery.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

FIG. 1 is a drawing of a building equipped with a HVAC system in which the systems and method of the present disclosure may be implemented, according to an exemplary embodiment.

FIG. 2 is a drawing of a sensory communication device according to an exemplary embodiment.

FIG. 3 is a drawing illustrating the installation of the sensory device of FIG. 2 according to an exemplary embodiment

FIG. 4 is a block diagram illustrating a first communication infrastructure utilizing the sensory device of FIG. 2 according to an exemplary embodiment.

FIG. 5 is a block diagram illustrating a second communication infrastructure utilizing the sensory device of FIG. 2 according to an exemplary embodiment.

FIG. 6 is a drawing further illustrating the first communication infrastructure of FIG. 4 according to an exemplary embodiment.

FIG. 7 is a drawing further illustrating the second communication infrastructure of FIG. 5 according to an exemplary embodiment.

FIG. 8 is a flowchart illustrating a first process of supplying a source of backup power according to an exemplary embodiment.

FIG. 9 is a flowchart illustrating a second process of supplying a source of backup according to an exemplary embodiment.

FIG. 10 is a drawing illustrating the communication between the sensory device of FIG. 2 and a cloud database according to an exemplary embodiment.

FIG. 11 is a drawing illustrating the communication between the sensory device of FIG. 2 and a mobile device according to an exemplary embodiment.

### DETAILED DESCRIPTION

### Overview

Referring generally to the FIGURES, a building management system, feedback controller, and components thereof are shown according to various exemplary embodiments. At the most fundamental level, feedback control leverages measurements to make decisions about how to manipulate the inputs of a system so that the controlled system achieves an expected or desirable behavior. Traditionally, wired sensors are used in feedback control systems. However, with the increasing availability and capacity of wireless sensors and wireless communication networks, wireless sensors are becoming a viable alternative to wired sensors.

In a building HVAC system, wireless sensors may be used to monitor a variety of building conditions such as temperature, humidity, pressure, airflow, air quality, occupancy, carbon monoxide, smoke, etc. For example, a wireless temperature sensor may be used to measure the temperature of a building zone and send zone temperature measurements to a feedback controller. The controller subsequently computes control inputs that ensure the zone temperature (i.e., the measured variable) is maintained at a zone temperature setpoint.

In some BMS systems, individual spaces or groups of spaces may be monitored and/or controlled by a device assigned to the particular space or group of spaces. These devices may include hard-wired devices such as space environment controllers (e.g., thermostats) and various sensors (e.g., occupancy sensors, temperature sensors, humidity sensors, air quality sensors, carbon monoxide sensors, smoke sensors, etc.). An issue with hard-wired devices is the difficulty to modulate, update, and expand the BMS for a particular space or group spaces. For example, if an occupancy sensor is to be installed into a space, the installation may require an electrician to access the wires contained in a wall in order to electrically and communicably (e.g., with a BMS controller) install the occupancy sensor.

In cases where wireless sensors and wireless communication are used, battery energy capacity and maintenance becomes an issue. Some sensors (e.g., occupancy sensors) consume a large amount of energy provided by a battery in order to measure and transmit a measurement. Additionally, some sensors continuously operate and, therefore, continuously consume energy. For example, an occupancy sensor may continuously collect occupancy data of a zone and continuously transmit the occupancy data to a controller. An attempt to reduce the amount of energy consumed from the battery is to provide wireless communication via a Bluetooth communication infrastructure. However, range issues arise with the use of Bluetooth communication. Devices are restricted to communicate within a particular distance in order for the devices to transmit messages to one another. The restricted communicable distances may present issues in large buildings where devices may need to communicate across greater distances than Bluetooth communication allows.

A solution to the issue is a sensory device described herein. The sensory device includes the ability to plug into a wall outlet and access an external power supply, host a Wi-Fi communication method, and measure environment data (e.g., temperature, humidity, pressure, air quality, occupancy, carbon monoxide, smoke, etc.) of a space or group of spaces. The sensory device may further include additional features such as a feedback controller capable of outputting commands to space environment devices (e.g., air conditioners, etc.). With the ability to communicate via a Wi-Fi communication infrastructure, the sensory device is not limited to allowable communication distance in order to communicate with other devices.

The sensory device provides an on-demand installation opportunity with the ability to plug into an electrical outlet and avoiding the need to access wires contained within walls. The on-demand installation of the sensory device helps to avoid higher installation costs associated with processes such as breaking into a wall and running wire (e.g., electrical, communication, etc.) to the device. The sensory device also provides a solution to updating conventional devices to modern technology. Additionally, with the ability for the sensory device to plug into an electrical outlet, the requirement of providing battery power and maintaining battery maintenance is avoided.

Before discussing the FIGURES in detail, it should be noted that the examples provided in the present disclosure are illustrative only and are not limitations on the scope of invention.

### Building Management System and HVAC System

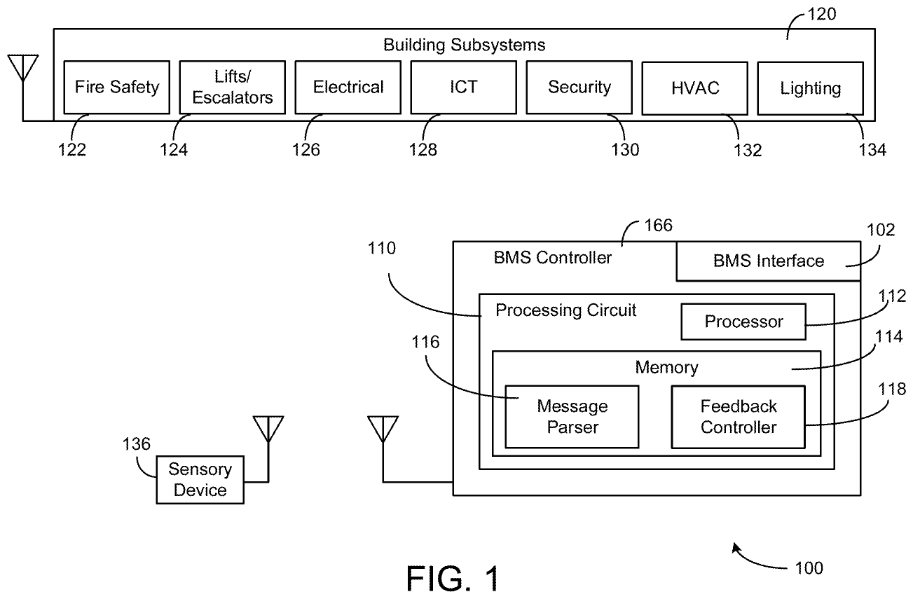

Referring to FIG. 1, a block diagram of a building management system (BMS) 100 is shown, according to an exemplary embodiment. BMS 100 may be implemented in a building to automatically monitor and control various building functions. BMS 100 is shown to include BMS controller 166 and a plurality of building subsystems 120. Building subsystems 120 are shown to include a fire safety system 122, a lift/escalators subsystem 124, a building electrical subsystem 126, an information communication technology (ICT) subsystem 128, a security subsystem 130, a HVAC subsystem 132, and a lighting subsystem 134. In various embodiments, building subsystems 120 can include fewer, additional, or alternative subsystems. For example, building subsystems 120 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control a building.

Each of building subsystems 120 may include any number of devices, controllers, and connections for completing its individual functions and control activities. For example, HVAC subsystem 132 may include a chiller, a boiler, any number of air handling units, economizers, field controllers, supervisory controllers, actuators, temperature sensors, and other devices for controlling the temperature, humidity, airflow, or other variable conditions within a building. Lighting subsystem 134 may include any number of light fixtures, ballasts, lighting sensors, dimmers, or other devices configured to controllably adjust the amount of light provided to a building space. Security subsystem 130 may include occupancy sensors, video surveillance cameras, digital video recorders, video processing servers, intrusion detection devices, access control devices and servers, or other security-related devices.

BMS controller 166 may communicate with a sensory device 136. In some embodiments, sensory device 136 may be a device assigned to a specific space or group of spaces. In some embodiments, device 136 may include a sensor. For example, device 136 may include wireless communication abilities and may be able to transmit measured and/or battery data values to BMS controller 166. In some embodiments, device 136 may be capable of transmitting control commands to a system capable of controlling an environment in a particular space or group of spaces. In some embodiments, device 136 may be capable of transmitting control data (e.g., temperature setpoints, humidity setpoints, etc.) to BMS controller 166. The features and operation of device 136 will be described in greater detail below. Control data may be any data which affects operation of the BMS. In some embodiments, control data may control building subsystems 120 through BMS controller 166. For example, device 136 may send a signal with a command to enable intrusion detection devices of security subsystem 130.

It is contemplated that sensory device 136 may communicate with building subsystems 120 directly. BMS controller 166 may transmit building data to device 136 for processing or analysis. Building data may include any relevant data obtained from a component within the building or pertaining to a portion or subsystem of the building. For example, building data may be data from sensors, status control signals, feedback signals from a device, calculated metrics, setpoints, configuration parameters, etc. In some implementations, building data is derived from data collected.

BMS controller 166 also includes BMS interface 102. BMS interface 102 may facilitate communication between BMS controller 166 and building susbsystems (e.g., HVAC, lighting, security, lifts, power distribution, etc.). BMS interface 102 can be or include wired or wireless communication interfaces (e.g., jacks, antennas, transmitters, receivers, transceivers, wire terminals, etc.) for conducting data communication with building subsystems 120 or other external systems or devices. In various embodiments, communication via BMS interface 102 may be direct (e.g., local wired or wireless communication) or via a communication network (e.g., a WAN, the Internet, a cellular network, etc.). For example, BMS interface 102 can include an Ethernet card and port for sending and receiving data via an Ethernet-based communication link or network. In another example, BMS interface 102 can include a Wi-Fi transceiver for communicating via a wireless communication network. In yet another example, BMS interface 102 may include cellular or mobile phone communication transceivers.

Still referring to FIG. 1, BMS controller 166 is shown to include a processing circuit 110. Processing circuit 110 includes a processor 112 and memory 114. Processor 112 can be implemented as a general-purpose processor, an application specific integrated circuit (ASIC), one or more field programmable gate arrays (FPGAs), a group of processing components, or other suitable electronic processing components.

Memory 114 (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present application. Memory 114 may be or include volatile memory or non-volatile memory. Memory 114 may include database components, object code components, script components, or any other type of information structure for supporting the various activities and information structures described in the present application. According to an exemplary embodiment, memory 114 is communicably connected to processor 112 via processing circuit 110 and includes computer code for executing (e.g., by processing circuit 110 and/or processor 112) one or more processes described herein.

In some embodiments, BMS controller 166 is implemented within a single computer (e.g., one server, one housing, etc.). In various other embodiments BMS controller, may be distributed across multiple servers or computers (e.g., that can exist in distributed locations). For example, BMS controller 166 may be implemented as part of a METASYS® brand building automation system, as sold by Johnson Controls Inc. In other embodiments, BMS controller 166 may be a component of a remote computing system or cloud-based computing system configured to receive and process data from one or more building management systems. For example, BMS controller 166 may be implemented as part of a PANOPTIX® brand building efficiency platform, as sold by Johnson Controls Inc. In other embodiments, BMS controller 166 may be a component of a subsystem level controller (e.g., a HVAC controller), a subplant controller, a device controller (e.g., a chiller controller, etc.), a field controller, a computer workstation, a client device, or any other system or device that receives and processes data.

Still referring to FIG. 1, memory 114 is shown to include a message parser 116 and a feedback controller 118. Modules 116 and 118 may be configured to receive inputs from building subsystems 120, sensory device 136, and other data sources, determine optimal control actions for building subsystems 120 based on the inputs, generate control signals based on the optimal control actions, and provide the generated control signals to building subsystems 120. The following paragraphs describe some of the general functions performed by each of modules 116 and 118 in BMS 100.

Message parser 116 may be configured to parse data received by BMS controller 166. For example, a message containing multiple data values (e.g., measured values and/or battery energy value) may be received by BMS controller 166. Message parser 116 may be configured to parse the message and extract the multiple data values. Message parser 116 may provide one value at a time to feedback controller 118. In yet other embodiments, message parser 116 may provide only values of a certain type to feedback controller 118. For example, message parser 116 may only provide measured values to feedback controller 118. In some embodiments, message parser 116 can work with feedback controller 118 to optimize building performance (e.g., efficiency, energy use, comfort, or safety) based on inputs received at BMS interface 102.

Message parser 116 may be configured to parse battery data received by BMS controller 166. In some embodiments, a message containing a remaining battery energy value may be received by BMS controller 166. Message parser 116 may be configured to parse the message and extract the battery energy value. In other embodiments, a message containing an event identification (e.g., sleep, wake, measure, etc.) and an event count may be received by BMS controller 166. Message parser 116 may be configured to parse the message and extract the event identification and event count.

### Sensory Device

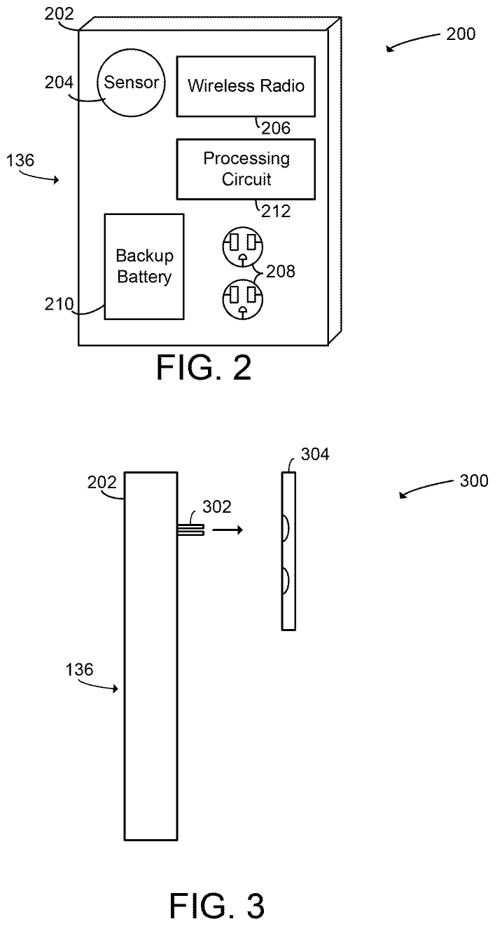

Referring now to FIG. 2, a detailed view 200 of sensory device 136 is shown according to an exemplary embodiment. Device 136 is shown to include various components including a housing 202, a sensor 204, a wireless radio 206, two electrical outlets 208, a backup battery 210, and a processing circuit 212. In some embodiments, device 136 may include additional components (e.g., user interface, control buttons/switches, lights, etc.). In other embodiments, device 136 may include fewer or any combination of components. In some embodiments, device 136 may include ports allowing for the installation of additional modules (e.g., additional sensors, lights, processors, etc.). The functions and methods of each component will be described in greater detail below.

Housing 202 is shown to include sensor 204, wireless radio 206, electrical outlets 208, and processing circuit 212, according to an exemplary embodiment. In some embodiments, processing circuit 212 may be capable of processing relating to the operation of device 136. Further, in some embodiments, processing circuit 212 may include a feedback controller. A feedback controller may be capable of leveraging measurements to make decisions about how to manipulate the inputs of a system (e.g., measurements collected by sensor 204) so that the controlled system achieves an expected or desirable behavior. Housing 202 may be formed of a material (e.g., plastic) capable of isolating (e.g., electrically, fluidly, etc.) from an external environment. Housing 202 may also be formed of any shape (e.g., circular, rectangular, triangular, etc.) allowing for adequate implementation of the included components.

Sensor 204 is shown to be included as a component of device 136 and located on or within housing 202 according to an exemplary embodiment. Sensor 204 may be any device capable of measuring an environment variable (e.g., temperature, humidity, occupancy, pressure, air quality, carbon monoxide, smoke, etc.). For example, sensor 204 may be a temperature sensor capable of measuring temperature of a zone. In some embodiments, sensor 204 may include additional sensors capable of measuring different environmental variables. In some embodiments, sensor 204 may be capable of outputting data containing a measurement of an environmental variable to a processing circuit contained within device 136.

Wireless radio 206 is shown to be included as a component of device 136 and located on or within housing 202 according to an exemplary embodiment. In some embodiments, wireless radio 206 may communicate with BMS controller 166. In other embodiments, wireless radio 206 may communicate with external devices (e.g., external wireless sensors, space environment control devices, user mobile devices, etc.). In some embodiments, wireless radio may be capable of communicating via a Wi-Fi communication infrastructure. In other embodiments, wireless radio may be capable of communicating via other wireless communication infrastructures (e.g., Bluetooth, cellular network, etc.). Further, in some embodiments, wireless radio 206 may be capable of transmitting data measured by sensor 204. In other embodiments, wireless radio 206 may be capable of transmitting data outputted by a processing circuit contained with device 136.

Electrical outlets 208 are shown to be included as components of device 136 and located on an external surface of housing 202 according to an exemplary embodiment. In some embodiments, device 136 may include additional outlets 208 (e.g., more than two). In other embodiments, device 136 may include fewer outlets 208 (e.g., less than two). Electrical outlets 208 may be capable of providing a source of power to external devices (e.g., charging devices, microwaves, phones, computers, televisions, lamps, etc.).

Referring now to FIG. 3, a system 300 is shown to illustrate the installation of device 136 according to an exemplary embodiment. System 300 is shown to include device 136, housing 202, a plug structure 302, and an electrical outlet 304. Electrical outlet 304 is shown as an external source of power according to an exemplary embodiment. In some embodiments, electrical outlet 304 may be located on a wall.

Plug structure 302 is shown to be located on an external surface of housing 202. In some embodiments, Plug structure 302 may be formed on a material capable of conducting electricity. Further, in some embodiments, plug structure may be capable of conducting electricity from an external power source to the internal components contained within housing 202. Plug structure 302 is shown to be capable of installation into electrical outlet 304 according to an exemplary embodiment. In some embodiments, plug structure 302 may be capable of physically supporting device 136 such that plug structure 302 remains inserted into electrical outlet 304 and an electrical circuit is completed between the internal components of device 136 and electrical outlet 304.

### Communication Infrastructure

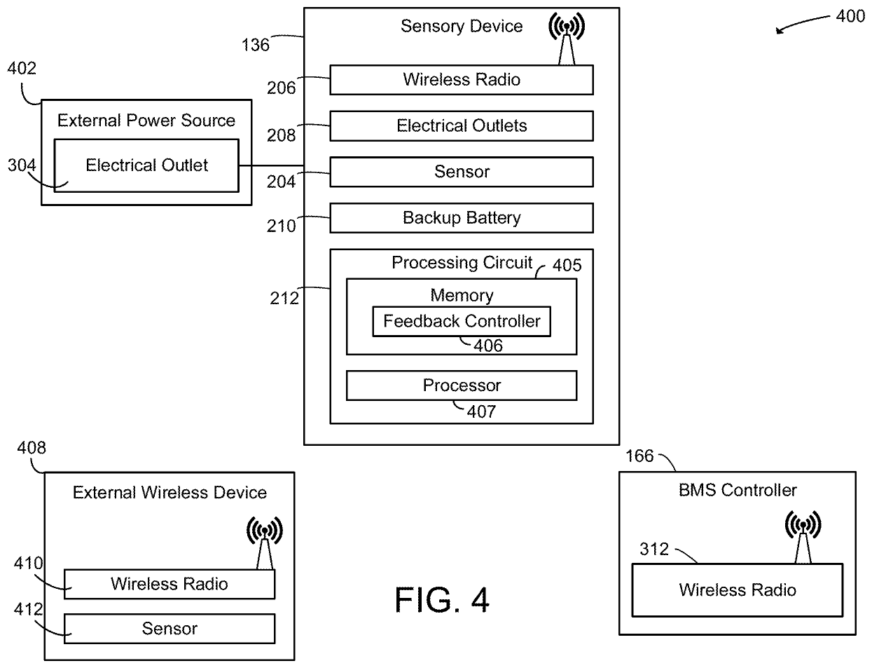

Referring now to FIG. 4, a system 400 illustrating a first communication infrastructure is shown according to an exemplary embodiment. The purpose of FIG. 4 is not intended to focus on the method of wireless communication (e.g., Bluetooth, Wi-Fi, cellular communication, etc.) but rather explain the devices and components that may be in wireless communication. System 400 is shown to include external power source 402, sensory device 136, external wireless device 408, and BMS controller 166.

External power source 402 is shown to include electrical outlet 304 according to an exemplary embodiment. External power source 402 may be a power supply from a building electrical grid, community electrical grid, renewable power source, or any power source that is not included as a component within device 136. In some embodiments, external power source 402 may be capable of providing a voltage (e.g., 120 V in USA) appropriate for the power consumption of device 136. Electrical outlet 304 may be capable of providing a point of electrical connection of sensory device 136 (e.g., via plug structure 302 referring to FIG. 3) to external power source 402 in order to supply device 136 with power from external power source 402.

Sensory device 136 is shown to include similar components referring to FIG. 2 including a processing circuit 212 according to an exemplary embodiment. Processing circuit 212 is also shown to include a memory 405 and a processor 407. Processor 407 can be implemented as a general-purpose processor, an application specific integrated circuit (ASIC), one or more field programmable gate arrays (FPGAs), a group of processing components, or other suitable electronic processing components.

Memory 405 (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present application. Memory 405 may be or include volatile memory or non-volatile memory. Memory 405 may include database components, object code components, script components, or any other type of information structure for supporting the various activities and information structures described in the present application. According to an exemplary embodiment, memory 405 is communicably connected to processor 407 via processing circuit 212 and includes computer code for executing (e.g., by processing circuit 212 and/or processor 407) one or more processes described herein.

Memory 405 is shown to include a feedback controller 406. Feedback controller 406 may communicate with processing circuit 212, wireless radio 206, and sensor 204. In some embodiments, feedback controller may receive data (e.g., measurements from external wireless device 408) via wireless radio 206. In some embodiments, feedback controller 406 may receive measurement data from sensor 204.

External wireless device 408 is shown to include wireless radio 410 and sensor 412. Sensor 412 may operate as a temperature sensor, humidity sensor, pressure sensor, occupancy sensor, air quality sensory, carbon monoxide sensor, smoke sensor or any sensor configured to measure an environmental variable. External wireless device 408 may be capable of transmitting data collected by sensor 412 to device 136 via wireless radio 410. The data collected by sensor 412 may be transmitted to feedback controller 406 within device 136 as an input to a feedback control algorithm executed by feedback controller 406. System 400 may include any number of external wireless devices 408 and is not limited to the example previously described. System 400 may include additional external wireless devices 408 capable of different operation (e.g., measuring different environmental variables).

BMS controller 166 is shown to include a wireless radio 312 according to an exemplary embodiment. BMS controller 166 may be capable of communicating with device 136 via wireless radio 312. In some embodiments, BMS controller 166 may receive measurements of an environmental variable collected by sensor 204 via wireless radio 312. In other embodiments, BMS controller 166 may receive control data from feedback controller 406 via wireless radio 312.

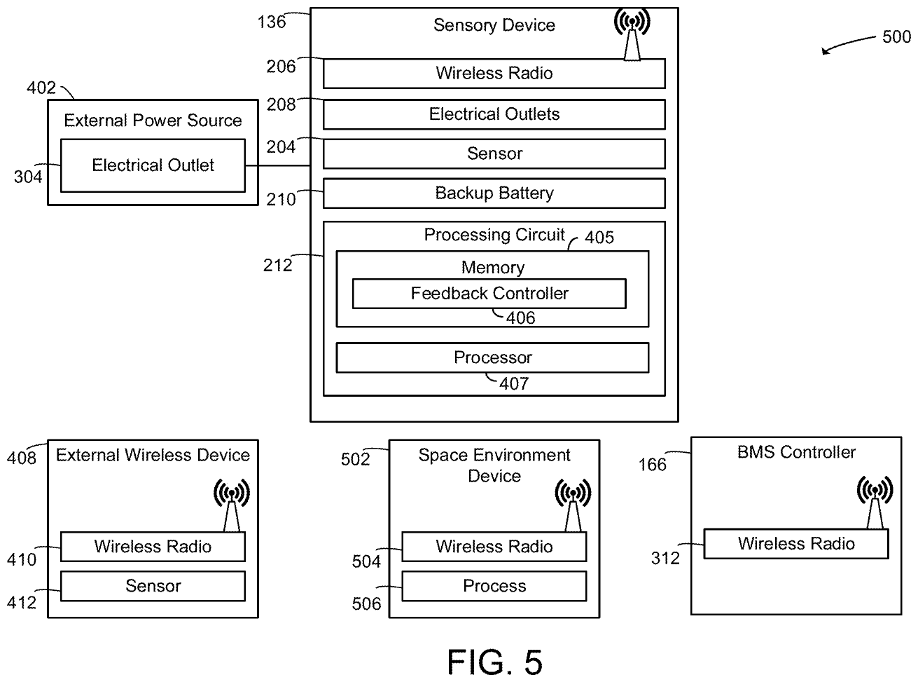

Referring now to FIG. 5, a block diagram of a system 500 illustrating a second communication infrastructure is shown according to an exemplary embodiment. The purpose of FIG. 5 is not intended to focus on the method of wireless communication (e.g., Bluetooth, Wi-Fi, cellular communication, etc.) but rather explain the devices and components that may be in wireless communication. System 500 is shown to include external power source 402, sensory device 136, external wireless device 408, BMS controller 166, and a space environment device 502 according to an exemplary embodiment.

The operation, features, and components of external power source 402, sensory device 136, external wireless device 408, and BMS controller 166 may be similar as previously described referring to FIG. 4. System 500 is shown to include space environment device 502. Space environment device 502 is shown to include a wireless radio 504 and a process 506. Space environment device 502 may be any device capable of completing a process 506 in order to change an environmental variable (e.g., an air conditioner capable adjusting humidity/temperature, a security system capable of locking doors/windows). For example, process 506 may include a process of enabling locks located on doors associated with a particular zone.

Space environment device 502 may be in wireless communication with device 136 via wireless radio 504. In some embodiments, space environment device 502 may receive control commands determined by feedback controller 406 via wireless radio 504. In other embodiments, space environment device may transmit state data (e.g., operation status, resource consumption, etc.) to sensory device 136. In some embodiments, space environment device 502 may be in wireless communication with BMS controller 166 via wireless radio 504. In some embodiments, space environment device 502 may receive a control command from sensory device 136, execute the control command from sensory device 136, and transmit a signal of an executed command to BMS controller 166. In some embodiments, space environment device 502 may be in wireless communication with additional components (e.g., external wireless device 408).

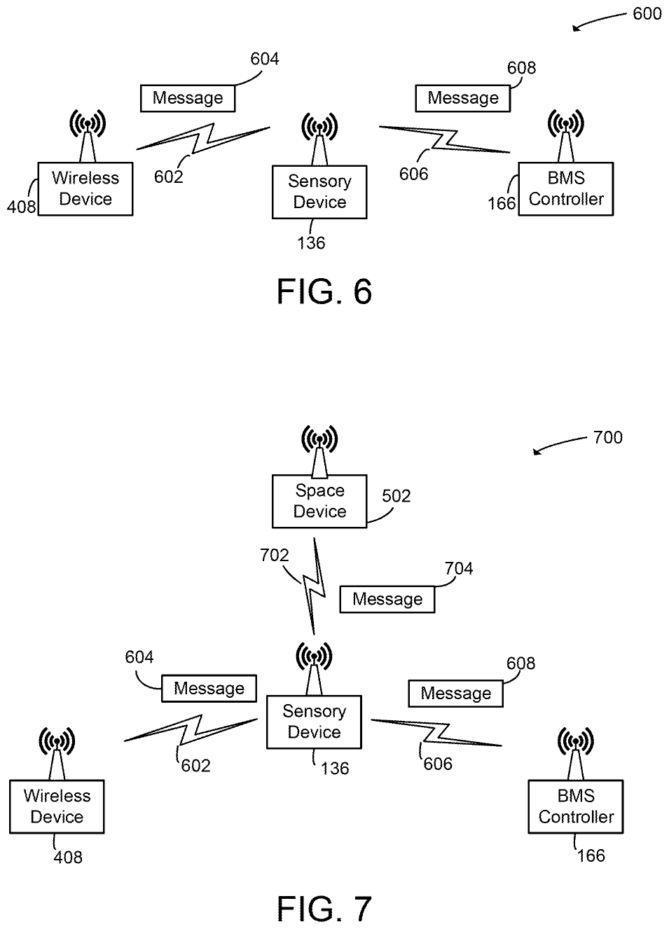

Referring now to FIG. 6, a system 600 is shown illustrating the communication described in FIG. 4 according to an exemplary embodiment. System 600 is shown to include sensory device 136, wireless device 408, and BMS controller 166. A transmission 602 of a message 604 is shown to be between wireless device 408 and sensory device 136. Additionally, a transmission 606 of a message 608 is shown to be between BMS controller 166 and sensory device 136.

In some embodiments, transmission 602 of message 604 may be from wireless device 408 to sensory device 136. In other embodiments, transmission 602 of message 604 may be from sensory device 136 to wireless device 408. Further, in other embodiments, transmission 602 of message 604 may be from wireless device 408 to BMS controller 166. Transmission 602 may include any wireless communication method (e.g., Bluetooth, Wi-Fi, cellular communication, etc.).

In some embodiments, message 604 may include a measurement of an environmental variable (e.g., temperature, humidity, pressure, etc.) measured by wireless device 408. In some embodiments, message 604 may include multiple measurements (e.g., more than one measurement of the same environmental variable, more than one measurement of different environmental variables, etc.). In some embodiments, message 604 may include a control action (e.g., wake up, power down, measure variable, etc.) to be executed by wireless device 408. In some embodiments, the contents of message 604 may depend on transmission 602 (e.g., from sensory device 136 to wireless device 408, from wireless device 408 to sensory device 136, etc.). The contents of message 604 is not intended to be limited to the examples previously described.

In some embodiments, transmission 606 of message 608 may be from BMS controller 166 to sensory device 136. In other embodiments, transmission 606 of message 608 may be from sensory device 136 to BMS controller 166. Further, in other embodiments, transmission 606 of message 608 may be from BMS controller 166 to wireless device 408. Transmission 606 is shown to include a Wi-Fi communication method. In other embodiments, transmission 606 may include any wireless communication method (e.g., Bluetooth, cellular communication, etc.).

In some embodiments, message 608 may include a measurement of an environmental variable (e.g., temperature, humidity, pressure, air quality, occupancy, carbon monoxide, smoke, etc.) measured by a sensor in sensory device 136. In some embodiments, message 608 may include multiple measurements (e.g., more than one measurement of the same environmental variable, etc.). In some embodiments, message 608 may include a control action (e.g., wake up, power down, measure variable, etc.) to be executed by sensory device 136. In some embodiments, the contents of message 608 may depend on transmission 606 (e.g., from sensory device 136 to BMS controller 166, from BMS controller 166 to sensory device 136, etc.). The contents of message 608 is not intended to be limited to the examples previously described.

Referring now to FIG. 7, a system 700 is shown illustrating the communication described in FIG. 5 according to an exemplary embodiment. System 700 is shown to include sensory device 136, wireless device 408, BMS controller 166, and space environment device 502. A transmission 602 of a message 604 is shown to be between wireless device 408 and sensory device 136. Additionally, a transmission 606 of a message 608 is shown to be between BMS controller 166 and sensory device 136. The operation, contents, and methods of transmission 602, message 604, transmission 606, and message 608 may be similar as previously described. A transmission 702 of a message 704 is also shown to be between sensory device 136 and space environment device 502.

In some embodiments, transmission 702 of message 704 may be from sensory device 136 to space environment device 502. In other embodiments, transmission 702 of message 704 may be from space environment device 502 to sensory device 136. Further, in some embodiments, transmission 702 of message 704 may be from space environment device 502 to wireless device 408. Further, in other embodiments, transmission 702 of message 704 may be from space environment device 502 to BMS controller 166. Transmission 702 is shown to include a Wi-Fi communication method. In other embodiments, transmission 702 may include any wireless communication method (e.g., Bluetooth, cellular communication, etc.).

In some embodiments, message 704 may include a control command (e.g., temperature setpoint, flow setpoint, wake up, warm up, go to sleep, etc.) to be executed by space environment device 502. In some embodiments, message 704 may include state data (e.g., operation status, resource consumption, etc.). In some embodiments, the contents of message 704 may depend on transmission 702 (e.g., from sensory device 136 to space environment device 502, from space environment device 502 to sensory device 136, etc.). The contents of message 704 is not intended to be limited to the examples previously described.

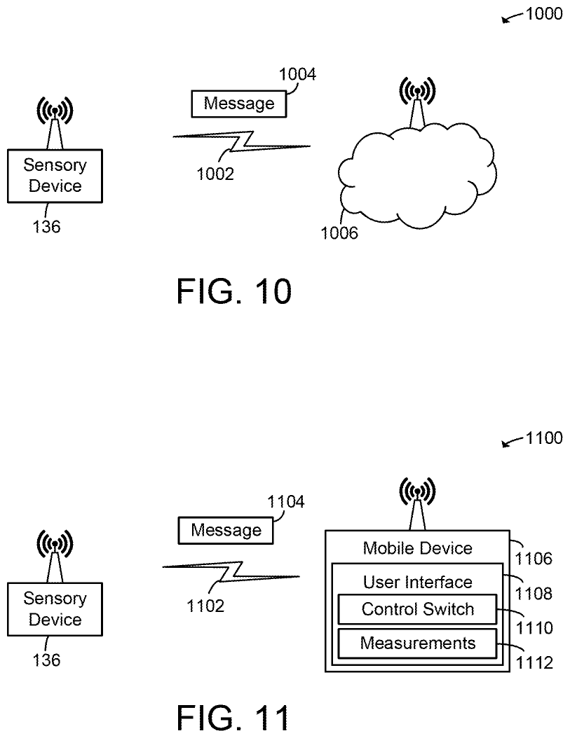

Referring now to FIG. 10, a system 1000 is shown illustrating the communication between sensory device 136 and a cloud database 1006 according to an exemplary embodiment. A transmission 1002 of a message 1004 is shown to be between sensory device 136 and cloud database 1006. Cloud database 1006 can include a variety of cloud-based services and/or applications configured to store, process, analyze, or otherwise consume the data collected from sensory device 136. Cloud database 1006 may be accessed by various users (e.g., enterprise users, mechanical contractors, cloud application users, etc.).

In some embodiments, transmission 1002 of message 1004 may be from cloud database 1006 to sensory device 136. In other embodiments, transmission 1002 of message 1004 may be from sensory device 136 to one or more additional devices (e.g., wireless device 408, BMS controller 166, space environment device 502, etc.). Transmission 1002 is shown to include Wi-Fi communication with cloud database 1006. In other embodiments, transmission 1002 may include any wireless communication method (e.g., Bluetooth, cellular communication, etc.).

In some embodiments, message 1004 may include a measurement of an environmental variable (e.g., temperature, humidity, pressure, air quality, occupancy, carbon monoxide, smoke, etc.) measured by sensor 204 included as a component of sensory device 136. In some embodiments, message 1004 may include multiple measurements (e.g., more than one measurement of the same environmental variable, more than one measurement of different environmental variables, etc.). The contents of message 1004 is not intended to be limited to the examples previously described.

Referring now to FIG. 11, a system 1100 is shown illustrating the communication between sensory device 136 and an application running on a mobile device 1106. A transmission 1102 of a message 1104 is shown to be between sensory device 136 and mobile device 1106. Mobile device 1106 may include any user device such as a smartphone, a smartwatch, a tablet, a laptop, or any other mobile device with the ability to run an application configured to receive message 1104 from sensory device 136.

Mobile device 1106 is shown to include a user interface 1108 according to an exemplary embodiment. User interface 1108 is shown to include a control switch 1110 and measurements 1112. In some embodiments, user interface 1108 may include a touchscreen allowing for a user to interact with control switch 1110 and measurements 1112. In other embodiments, user interface 1108 may include physical components (e.g., push buttons, switches, dials, etc.) allowing for a user to interact with control switch 1110 and measurements 1112.

In some embodiments, control switch 1110 allows a user to interact with and control sensory device 136. For example, control switch 1110 may include an on/off switch which allows a user to turn sensory device 136 on or off (e.g., enable power to be supplied to sensory device 136 or disable power to be supplied to sensory device 136). In some embodiments, control switch 1110 allows a user to control individual components included in sensory device 136. For example, control switch 1110 may include an on/off switch which allows a user to turn electrical outlets 208 on or off (e.g., enable power to be supplied to electrical outlets 208 or disable power to be supplied to electrical outlets 208). In other embodiments, control switch 1110 includes additional features allowing a user to control sensory device 136 and/or components included in sensory device 136. For example, control switch 1110 may include a button allowing for a user to send a command to sensor 204 to record a measurement at a specific time. Control switch 1110 may include any features that allows a user to interact with, control, and/or customize the operation of sensory device 136.

Measurements 1112 may be received by mobile device 1106 from sensory device 136 via message 1104. In some embodiments, measurements 1112 may be received by mobile device 1106 from sensors 412 included in wireless device 408. In some embodiments, measurements 1112 are shown on a screen provided by user interface 1108. For example, one or more measurements 1112 (e.g., temperature, humidity, pressure, air quality, occupancy, carbon monoxide, smoke, etc.) may be presented to a user by user interface 1108. In some embodiments, measurements 1112 includes present-time measurements received from sensory device 136 and/or wireless device 408. In other embodiments, measurements 1112 includes historical measurements received from sensory device 136 and/or wireless device 408. For example, measurements 1112 may include a graph or showing historical values of an environmental variable.

In some embodiments, transmission 1102 of message 1104 may be from mobile device 1106 to sensory device 136. In other embodiments, transmission 1102 of message 1104 may be from sensory device 136 to one or more additional devices (e.g., wireless device 408, BMS controller 166, space environment device 502, etc.). Transmission 1102 is shown to include Wi-Fi communication with mobile device 1106. In other embodiments, transmission 1102 may include any wireless communication method (e.g., Bluetooth, cellular communication, etc.).

In some embodiments, message 1104 may include a measurement of an environmental variable (e.g., temperature, humidity, pressure, air quality, occupancy, carbon monoxide, smoke, etc.) measured by sensor 204 included as a component of sensory device 136. In some embodiments, message 1104 may include multiple measurements (e.g., more than one measurement of the same environmental variable, more than one measurement of different environmental variables, etc.). The contents of message 1104 is not intended to be limited to the examples previously described.

Referring generally to FIGS. 6, 7, 10, and 11, further wireless communication may involve transmitting messages between sensory device 136 and one or more thermostat devices located within a building (e.g., Johnson Controls' GLAS smart thermostat). Communication between sensory device 136 and thermostats may provide thermostats with more accurate and up-to-date data (e.g., temperature data, air quality data, humidity data, occupancy data, carbon monoxide data, etc.) in order to more accurately control environmental variables of zones located within a building.

### Backup Power System

Referring to FIGS. 2, 4, and 5, device 136 is shown to include a backup battery 210. Backup battery 210 may be any source of power (e.g., chemical, renewable, etc.) that may be capable of providing a source of power if external power source 402 (referring specifically to FIGS. 4 & 5) is not available (e.g., a power line event causing a power outage, etc.). In some embodiments, processing circuit 212 (referring specifically to FIGS. 4 & 5) may be capable of detecting when external power source 402 is not available. In some embodiments, processing circuit 212 may be capable of activating backup battery 210 (e.g., turn on) in order to power sensory device 136.

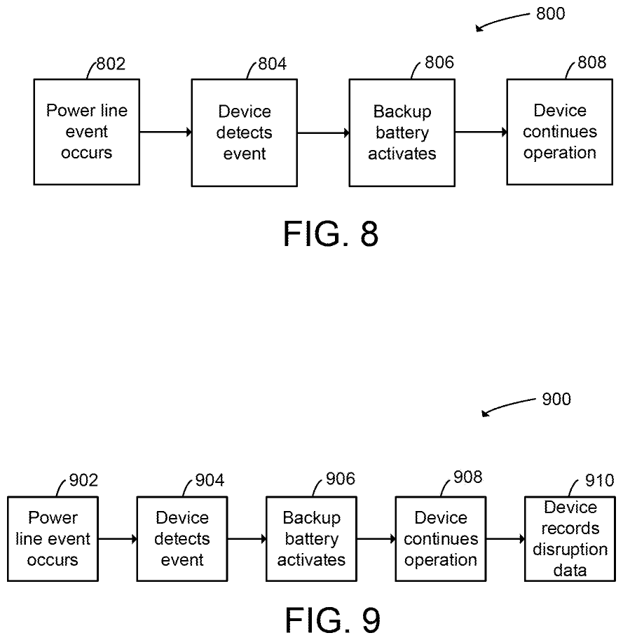

Referring now to FIG. 8, a process 800 of supplying a source of backup power to device 136 is shown according to an exemplary embodiment. In some embodiments, process 800 may involve processing circuit 212 and backup battery 210 (referring to FIGS. 4 & 5). Process 800 begins with step 802. Step 802 may involve a power line event occurring. A power line event may include a power surge, power outage, etc. A power line event may include any event the causes a change (e.g., change in magnitude, change in frequency, etc.) in power from an external power source supplied to device 136.

Process 800 proceeds with step 804. Step 804 may include device 136 detecting the power line event. In some embodiments, processing circuit 212 may detect the power line event. In other embodiments, other methods (e.g., fuse, short circuit, etc.) of detection may be used. Following step 804, process 800 continues with step 806. Step 806 may involve the activation of a backup battery within device 136. In some embodiments, step 806 may include processing circuit 212 transmitting a control command (e.g., turn on) to a backup battery. The activation involved in step 806 may depend on the power generation method (e.g., chemical, solar, wind, etc.) of a backup battery.

Process 800 is shown to conclude with step 808. Step 808 may involve device 136 resuming operation. In some embodiments, step 808 may involve a reduced operation (e.g., not providing power to outlets located on device 136, not operating other components that may not be imperative to controlling an environment of a space, etc.). In other embodiments, step 808 may involve a normal operation (e.g., all components and features of device 136 operating).

Referring now to FIG. 9, a process 900 of supplying a source of backup power to device 136 is shown according to an exemplary embodiment. In some embodiments, process 900 may involve processing circuit 212 and backup battery 210 (referring to FIGS. 4 & 5). Steps 902, 904, 906, and 908 may be similar to steps 802, 804, 806, and 808 of process 800 (referring to FIG. 8). Additionally, process 900 is shown to include a step 910.

Step 910 may involve device 136 recording data relating to the power line event. In some embodiments, step 910 may involve processing circuit 212 of device 136 recording a time duration that an external power source is unavailable. Further, in some embodiments, step 910 may involve a time at which an external power source becomes unavailable. In other embodiments, step 910 may involve recording a measurement of energy consumed form a backup battery within device 136.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A sensory communication device for a building space, the device comprising:
a housing;
a plug structure coupled to the housing and insertable into an electrical outlet to receive power from the electrical outlet, the plug structure configured to support the housing when inserted into the electrical outlet;
one or more sensors located at least partially within the housing and configured to measure one or more environmental variables within the building space;
a wireless radio configured to transmit measurements of the one or more environmental variables; and
one or more electrical outlets located on an external surface of the housing and electrically coupled to the plug structure to provide power to one or more external devices.

2. The sensory communication device of claim 1, further comprising a feedback controller located within the housing and configured to:
receive a value of the one or more environmental variables from the one or more sensors;
use the value of the one or more environmental variables to generate a control command for at least one space environment control device that operates to affect the one or more environmental variables; and
output the control command to the at least one space environment control device.

3. The sensory communication device of claim 1, wherein the wireless radio is configured to transmit the measurements of the one or more environmental variables to a building management system.

4. The sensory communication device of claim 1, further comprising a feedback controller configures to:
receive a plurality of values of an environmental variable from at least one external wireless device;
use the plurality of values of an environmental variable to generate a plurality of control commands for at least one space environment control device that operates to affect a plurality of environmental variables; and
output the plurality of control commands to the at least one space environment control device.

5. The sensory communication device of claim 1, further comprising a plug load sensor configured to measure a power consumption of the one or more external devices plugged into the electrical outlets.

6. The sensory communication device of claim 5, wherein the wireless radio is configured to transmit at least one measurement of the power consumption of the one or more external devices received from the plug load sensor.

7. The sensory communication device of claim 1, wherein the plurality of electrical outlets is configured to provide 120 AC power to the plurality of external devices.

8. The sensory communication device of claim 1, further comprising a backup battery configured to store and provide power to at least one of the one or more sensors, the wireless radio, or the one or more electrical outlets.

9. A method for controlling a space environment, the method comprising:
providing a sensory communication device configured to receive power from an external power source;
electrically coupling the sensory communication device to an electrical outlet, the electrical outlet providing power from the external power source; and
powering the sensory communication device with power provided by the external power source; and
measuring at least one environmental variable by locating one or more sensors at least partially within a housing; and
transmitting at least one measurement of the at least one environmental variable; and
providing one or more electrical outlets located on an external surface of the housing to one or more external devices.

10. The method of claim 9, wherein powering the sensory communication further comprises supplying power from an electrical infrastructure contained within a building.

11. The method of claim 9, wherein providing the sensory communication device further comprises providing a backup battery.

12. The method of claim 9, wherein providing one or more electrical outlets further comprises providing 120 AC power to the one or more external devices.

13. The method of claim 9 further comprising measuring a power consumption value of the one or more external devices plugged into one or more electrical outlets.

14. The method of claim 9 further comprising:
receiving a plurality of values of an environmental variable from at least one external wireless device;
using the plurality of values of an environmental variable to generate a plurality of control commands for at least one space environment control device operating to affect the plurality of environmental variables; and
transmitting the plurality of control commands to the at least one space environment control device.

15. A plug-in controller device comprising:
a housing;
a plug structure coupled to the housing and insertable into an electrical outlet to receive power from the electrical outlet, the plug structure configured to support the housing when inserted into the electrical outlet;
one or more sensors located at least partially within the housing and configured to measure one or more environmental variables within a building space;
a processing circuit comprising a feedback controller located within the housing, the feedback controller configured to:
receive a plurality of values of one or more environmental variables from the one or more sensors;
determine a plurality of control commands based on the plurality of values of one or more environmental variables; and
output the plurality of control commands.
a wireless radio configured to:
transmit the plurality of control commands determined by the feedback controller to at least one space environment control device; and
one or more electrical outlets located on an external surface of the housing and configured to electrically couple to the plug structure and to provide power to one or more external devices.

16. The device of claim 15, wherein the wireless radio is further configured to receive the plurality of values of one or more environmental variables from at least one external wireless devices.

17. The device of claim 15, wherein the wireless radio is further configured to transmit at least one measurement of power consumption of the one or more external devices received from a plug load sensor.

18. The device of claim 15, wherein the one or more electrical outlets is configured to provide 120 AC power to the plurality of external devices.

19. The device of claim 15, wherein the plug-in controller device further comprises a backup battery configured to provide an emergency power supply.

20. The device of claim 19, wherein the feedback controller is further configured to detect a power line event and activate the emergency power supply supplied by the backup battery.
